(19) United States
(12) Patent Application Publication
(10) Pub. No.: US 2025/0182640 A1
(43) Pub. Date: Jun. 5, 2025

(54) SEGMENTATION OF IMAGES ONTO PHYSICALLY SEPARABLE DEVICES AND REASSEMBLY FOR EDUCATION, THERAPY, AND ENTERTAINMENT

(71) Applicant: Tusi, LLC, Lafayette, IN (US)

(72) Inventors: Jurgen ZACH, Lafayette, IN (US); Karun TAHILRAMANI, Chesapeake, VA (US)

(21) Appl. No.: 18/843,679

(22) PCT Filed: Mar. 1, 2023
(86) PCT No.: PCT/US2023/014305

§ 371 Date: Sep. 3, 2024

(51) Int. Cl. G09B 5/06; A63F 9/06; A63F 9/12

(52) U.S. Cl. CPC G09B 5/065; A63F 9/0612; A63F 9/1204

(57) ABSTRACT

A method for segmenting a digital image onto reconfigurable puzzle pieces is disclosed. The digital image is segmented into a set of sub-images using a first processing unit. The set of sub-images along with meta-data is transmitted to a set of second processing units or a set of puzzle components. Each puzzle component comprises at least one data memory to store the image, one or more display screens to display the sub-image, at least one program memory to execute a set of instructions to control the display of sub-images on one or more display screens, and one or more connectors to permit the mechanical connections between the puzzle components such that their aligned display screens comprise composite images. Each puzzle component identifies the attached other puzzle components through the connector. The assembly of the composite images supports educational, medical, therapeutic, or entertainment goals of a user assembling the puzzle components.

### TECHNICAL FIELD

The present invention generally relates to disassembling and assembling digital images. More specifically, the present invention relates to the segmentation of digital images onto physically separable devices and the reassembly of such devices for education, therapy, and entertainment.

### BACKGROUND

Assembling digital images from composite images has many proven benefits in education, therapy, and intellectually stimulating game play. Overall, the most wide-spread approach among existing products, especially in recreational or therapy settings, are fully digital representations of puzzles, in which puzzles are represented as software on a display screen of existing personal computers, tablets, smartphones, or other devices, to be assembled by interacting with a digital device through common user input devices such as touch-sensitive screens, mice, joysticks, trackballs, or similar devices. All common implementations of such digitally reconfigurable puzzles are displayed on a single display screen, and the composite images are only virtually separated.

With the overall trend of increasing screentime of both children and adults, there is also a movement towards learning- and therapy tools as well as pastimes that avoid reliance on too much digital content, for which present digital segmented puzzles are examples. In particular, there is an unmet demand for puzzles that have the configurability of digital software representations of puzzles, but that interact with the learner, child, or therapy patient through means that are more tactile.

There are existing implementations of puzzles centered on assembling composite images from segmented partial images, but they center on a purely digital representation of a puzzle. While being reconfigurable and compatible with multimedia capabilities, they cannot be considered compatible with the idea of a puzzle physically assembled from detached partial images. The present invention aims to combine a fundamentally non-digital concept as a contrast to the increasing digital exposure and screentime learners are exposed to with reconfigurable digital features that render said non-digital concept more interesting. After decades of increased digital content in learning, education, and play, some sectors experience a movement against the ever-increasing screentime among children and adults and seek out experiences that are more multisensory and include the sense of touch, and the best way that can be achieved is by adopting the concept of detachable puzzle pieces for the image segments, which sets it apart from purely digital puzzle implementations. Henceforth, the terms “Puzzle Piece” and “Puzzle Component” are used interchangeably and shall refer to physically detachable units with at least one display screen.

Beyond the mainly digital representations in the art, a method to combine physical objects and digital representations is Augmented Reality (AR) technologies, in which digitally generated objects are superimposed on an image, such as a photograph or movie, of the physical world. The present invention shares some applications but is not an AR technology.

Some existing prior art includes inventions of puzzle pieces depicting moving images in some form, however, they are implemented purely on digital devices with the puzzle pieces depicted on a single screen. Therefore, these inventions do not represent reconfigurable, physically separable puzzle pieces displaying segmented movies or dynamically changing image segments, as the presented invention does. The same applies to some prior art that combines music with the assembly of digital representations of puzzle pieces, whereas the present invention represents an enhancement to detachable puzzle pieces.

Examples exist in the art that involve image segmentation but do not include physically separable puzzles which are to be assembled (as is realized in the invention presented). In terms of delivery of images, some prior art centered on content delivery through a networked system, (e.g., the internet), as it is part of some embodiments of the present invention; however, none previewed a puzzle with detachable pieces to distribute content, such as images. Among prior art for data delivery, including visual data, are learning management systems, but none preview puzzles with detachable pieces holding segmented images. Further, Blockchain-related prior art was found, but none related to a puzzle as described herein.

Hence, there is a need for a method for segmenting images and assembling of images. Also, there is a need for a method of segmenting images onto physically separable devices through data networks and reassembly for education, therapy, and entertainment.

### SUMMARY

The present invention generally discloses disassembling and assembling of images. Also, the present invention discloses a method of segmenting images onto physically separable devices through data networks and reassembly for education, therapy, and entertainment.

In one embodiment, a reconfigurable puzzle comprises a set of puzzle pieces or part of a set of puzzle pieces. The reconfigurable puzzle consists of individual puzzle pieces with reconfigurable electronic display screens on at least one side. A portion of the puzzle set is assembled, and the missing puzzle pieces are in the process of being attached. When assembled, the configuration may have a unique Correct Solution. The reconfigurable puzzle can be generalized to images of any size by adding additional rows and columns. Notwithstanding any specific example, the scope of images to which the puzzle sets can be configured to by the Content Designer is wide, covering many applications including education, therapy, play, games, and play-based learning.

In some embodiments, the present invention includes means of connected puzzle pieces to detect the connection. In some embodiments, the present invention further includes means for the connected puzzle pieces to exchange data. The exchanged data may include the identification of the respective connected puzzle pieces through identifiers unique to one puzzle piece, and other data to be relayed to a puzzle piece, and yet other data received from a connected puzzle piece. In one embodiment, the exchanged data may include visual data for output on a display screen on a specific puzzle piece, data from sensors included on a specific puzzle piece, or any other data.

The puzzle sets are assembled by the learner or user by connecting at least two puzzle pieces along a continuous surface. In some embodiments, the surface may be two-dimensional (2D) and flat. In some embodiments, the surface may be three-dimensional (3D). In one embodiment, the reconfigurable puzzle set is configured by a Content Designer such that at least one possible said continuous surface formed by attaching said puzzle set's constituent puzzle pieces is defined as a “Correct Solution”, as defined by the Content Designer, of the puzzle set. In most embodiments, the continuous surface will form continuously connected, or possibly almost continuously connected with small gaps in between, display screens that comprise a composite image. A feature of most embodiments of the invention is non-unique Correct Solutions accessible to Content Designers.

In some embodiments, the puzzle piece may be, but not limited to, a flat cuboid puzzle piece or any other shape of individual puzzle pieces. It shall cover any connection mechanism in 2D or 3D, as long as the composite images can be attached together to form a Correct Solution.

In one embodiment, a method for segmenting a digital image onto reconfigurable puzzle pieces is disclosed. The method comprises the following steps. At one step, a digital image that covers a surface is segmented into a set of sub-images using a first processing unit with attached program memory to execute the segmentation program and data memory to store images. At another step, the set of sub-images, along with meta-data indicating the position of the sub-images within the overall image and other information related to the image, are transmitted to a set of second processing units or puzzle components. In one embodiment, each sub-image is transmitted to one puzzle component.

In one embodiment, each puzzle component comprises at least one data memory configured to store the image, one or more display screens configured to display the sub-image, at least one program memory configured to execute a set of instructions to control the display of sub-images on one or more display screens, and one or more connectors configured to permit the puzzle components forming mechanical connections that result in an alignment of display screens belonging to different puzzle components, such that display screens of thus connected puzzle components form part of a composite image.

At another step, two or more puzzle components are assembled together using one or more connectors such that their aligned display screens comprise composite images. In one embodiment, each puzzle component identifies the other puzzle component that is attached to through a connector. The user assembling the puzzle components interacts with at least one puzzle component with an attached user feedback sensor with the interaction resulting in a modified image displayed on at least one display screen of any puzzle component. In one embodiment, the assembly of the composite images is configured to support educational, medical, therapeutic, or entertainment goals of a user assembling the puzzle components.

In one embodiment, the method provides a customized image and customized segmentation of at least one image for a specific client configured to provide a positive therapeutic, educational, or developmental result. In one embodiment, the specific client interacts with the assembled puzzle components through one or more user input sensors attached to the at least one puzzle component with the attached user feedback sensor wherein a modified image is displayed on at least one display screen of any puzzle component in response to the specific client interaction.

In one embodiment, a group of at least one client in an education, therapy, or developmental setting determines a series of customized themes depicted as images and a series of customized segmentations of the images for education, therapy, or developmental setting following established quantitative and evidence-based methods on the education, therapy, or developmental field, when members of said group assemble said customized segmented images into a whole image.

In one embodiment, the at least one puzzle component is attached to at least one sensor that permits user input, comprises a haptic feedback sensor including a touchscreen, or a voice feedback sensor including a microphone with an attached audio processor. In one embodiment, the method records a duration of puzzle components assembled together as a time record, wherein the time record of assemblies and disassemblies of pair-wise puzzle components is saved in the data memory, resulting in an assembly record.

In one embodiment, the user, while assembling the puzzle components, interacts with at least one puzzle component with attached user feedback sensor with the data generated by the interaction process in the second processing unit and the results of the processing is recorded in the data memory, resulting in a feedback record. The puzzle components generate a positive feedback signal for recovering the original image of the puzzle that covers the surface or another configuration that is set as another correct solution of the puzzle to recover the original image. In one embodiment, the puzzle components generate a negative feedback signal for not recovering the original image of the puzzle according to one of the correct solutions. The positive feedback signal and the negative feedback signal are recorded in a memory unit and analyzed to generate a quantitative completion record.

In one embodiment, the method analyzes the assembly record, feedback record, and quantitative completion record, resulting in at least one continuously updated quantitative proficiency score. The quantitative proficiency record evaluates the adequacy of the level of difficulty encountered by the user when assembling the puzzle pieces together. The method provides a quantitative exit score that measures the amount of exposure completed by the user to a specific segmented image. The exit score is compared with a predetermined threshold, once the exit score exceeds the threshold, the quantitative proficiency score is evaluated.

The quantitative proficiency score is compared to a second predetermined threshold. The series of customized themes depicted as images are modified towards images that are easier to assemble when segmented or towards a lower number of segments if the quantitative proficiency score is below the second predetermined threshold. The series of customized themes depicted as images are modified towards images that are more challenging to assemble when segmented, or the series of customized segmentations towards a greater number of segments if the quantitative proficiency score is above the second predetermined threshold.

The method transmits one or more regularly or irregularly tiled segments, wherein each tile segment comprising at least one image from a first data memory attached to the first processing unit to at least one second data memory attached to the second processing unit via a first data connection comprising at least one wired or wireless data network. In one embodiment, the tiled segments are distributed from the second data memory onto one or more third data memories through at least one second data connection comprising wired or wireless interfaces. Each third data memory is contained in a separate enclosure having one processing unit connected to the third data memory; at least one display screen connected to one of the processing units, and an electronic device to receive data through at least one of the wired or wireless interfaces, with the electronic device to receive data via the at least one second data connection, with the electronic device connected to one of the processing units. In one embodiment, each third data memory receives one tiled segment, for each at least one image, per at least one display screen contained in the corresponding enclosure, wherein the tiled segment is displayed on the attached display screen upon receiving on the third data memory or at a later time.

In one embodiment, the reconfigurable puzzle assembly is used for segmenting and reassembling images for education, therapy, and entertainment. The reconfigurable puzzle assembly comprises a set of puzzle pieces or a puzzle set having reconfigurable individual display screens on at least one side. In one embodiment, each puzzle piece comprises a sensor input integrated with the display screen configured to provide a significant amount of raw data. The sensor input is any one of a touchscreen, an audio-recording device, a haptic sensor, a microphone, a wearable sensor, a user input device, or any other sensor unit capable of interacting with a user.

In one embodiment, the puzzle piece further comprises a processing unit configured to perform edge processing of the raw data from the sensor input. In one embodiment, the processing unit is a microcontroller. The processing unit transmits control signals to the display screen and directs the display screen to show patterns in response to writing or drawing motions of a finger, stylus, or tool on the touchscreen. The processing unit performs machine learning or artificial intelligence (ML/AI) algorithms to interpret the sensor input. In one embodiment, the algorithms include image classification algorithms, neural network-based algorithms for processing written symbols that are labeled by one of a finite number of labels, or any other suitable image recognition algorithms.

In one embodiment, the puzzle set further comprises a data transmitting device configured to retrieve the preprocessed data from the processing units in the puzzle pieces via a wireless peer network connection. The preprocessed data may include edge processed data. The data transmitting device is any one of a data hub including a WiFi router or any other wireless networking device. The data transmitting device is a user device that includes or is connected to a device capable of communicating through any wireless communication protocol or RF protocols. The RF protocols may include, but are not limited to, WiFi, Bluetooth, BLE, Zigbee, Z-wave, or Thread. In one embodiment, the data resulting from the edge processing is displayed on the display screen.

In one embodiment, a system of content generating engine for generating content to be transmitted to a puzzle set is disclosed. The system comprises a computing device or content generating device configured to generate the content. The content generating device is a physical or virtual server for remote operation, running in at least one data center. The system further comprises another device or second device configured to communicate with the content generating device via at least one networked connection. In one embodiment, the system allows a user to operate the content generating device via the another device. In one embodiment, the another device is integrated with a graphics output and an optional sound output to preview any visual and optional audio content designed. In some embodiments, the another device is any one of a laptop, a desktop, a computer, a tablet, a smartphone, or any other computing device with similar capabilities and compatible data interfaces.

In one embodiment, the system further comprises one or more input devices having a touchscreen, mouse, keyboard, scanner, camera, or microphone, configured to design the content, wherein some of the input devices are directly connected to the another device. In one embodiment, the system further comprises a data repository with one or more databases of content accessible through a network and content generating device. The content compatible to the puzzle pieces are retrieved after initiation by a program running on the content generating device.

In one embodiment, the system further comprises a data transmitting device configured to receive the content from the content generating device through at least one data network. The content is then transmitted to the puzzle set, wherein each puzzle piece in the puzzle set comprises a display screen configured to display the content in an aligned manner.

In one embodiment, the system further utilizes a content analysis engine configured to receive and analyze sensor data generated by the user interacting with one or more input devices integrated in at least one puzzle piece from among the puzzle set. The content generating engine and content analysis engine rely on local user devices or cloud-based computing devices. The content generating engine delivers a subscription to curriculum content to the puzzle set (puzzle pieces). The content is retrieved from a database having data to be delivered that include images or series of images, movies, audio files, haptics programs, any other data output for at least one puzzle pieces, and programs and configuration files for at least one puzzle pieces. The content analysis engine retrieves data from the puzzle set following a schedule preset in time or dependent on analysis results of data retrieved from the puzzle set.

The above summary contains simplifications, generalizations, and omissions of detail and is not intended as a comprehensive description of the claimed subject matter but, rather, is intended to provide a brief overview of some of the functionality associated therewith. Other systems, methods, functionality, features, and advantages of the claimed subject matter will be or will become apparent to one with skill in the art upon examination of the following figures and detailed written description.

### BRIEF DESCRIPTION OF THE DRAWINGS

The description of the illustrative embodiments can be read in conjunction with the accompanying figures. It will be appreciated that for simplicity and clarity of illustration, elements illustrated in the figures have not necessarily been drawn to scale. For example, the dimensions of some of the elements are exaggerated relative to other elements. Embodiments incorporating teachings of the present disclosure are shown and described with respect to the figures presented herein, in which:

FIGS. 1A-1B show a set of puzzle pieces, or part of a set of puzzle pieces, during assembly and fully assembled, according to one embodiment of the present invention.

FIG. 2 shows a number of puzzle pieces form a complex 3D shape, according to one embodiment of the present invention.

FIG. 3 shows a learner interacting with a flat assembled puzzle set with some or all puzzle pieces equipped with touchscreens, where the puzzle piece is equipped with a processing unit to recognize patterns on the touchscreen, with a simple math problem shown as an example, according to one embodiment of the present invention.

FIG. 4 shows a peer meshed network of puzzle pieces interacting with an external device, according to one embodiment of the present invention.

FIG. 5 shows a centralized network of puzzle pieces interacting with an external device, according to one embodiment of the present invention.

FIG. 6 shows a peer meshed network of puzzle pieces interacting with more than one external devices, according to one embodiment of the present invention.

FIG. 7 shows a schematic diagram of wireless peer network with partial edge processing inside a puzzle piece, according to one embodiment of the present invention.

FIG. 8 shows a block diagram of a cloud-based Content Engine for a puzzle set, according to one embodiment of the present invention.

FIG. 9 shows a block diagram of a cloud-based Content Analysis Engine for a puzzle set, according to one embodiment of the present invention.

FIG. 10 shows a block diagram of a local Content Engine for a puzzle set, according to one embodiment of the present invention.

FIG. 11 shows a block diagram of a local Content Analysis Engine for a puzzle set, according to one embodiment of the present invention.

FIG. 12 shows a block diagram of a Content Engine with automated curriculum delivery for a puzzle set, according to one embodiment of the present invention.

FIG. 13 shows a block diagram of a Content Analysis Engine with automated curriculum analysis for a puzzle set, according to one embodiment of the present invention.

### DETAILED DESCRIPTION OF EXAMPLE EMBODIMENTS

A description of embodiments of the present invention will now be given with reference to the Figures. It is expected that the present invention may be embodied in other specific forms without departing from its spirit or essential characteristics. The described embodiments are to be considered in all respects only as illustrative and not restrictive.

As used herein, the term “Learner” or “User” (both terms are used interchangeably; plural: “Learners” or “Users”), anywhere in this document (other than differing definitions in Prior Art quoted) is referring to any and all of the following, unless stated otherwise: a student or pupil in a school, preschool, homeschool setting, kindergarten, daycare, college, university, adult continuing education, or any other formal or informal educational setting who is assembling or otherwise interacting with any embodiment of the present puzzle set in order to obtain an educational, learning, or teambuilding benefit; OR: a client or patient in a therapeutic, rehabilitation, or other medical setting, ordered or prescribed by a therapist or medical professional or otherwise, in an inpatient-, outpatient-, or home care setting, who is assembling or otherwise interacting with any embodiment of the present puzzle set in order to improve, train, or evaluate their cognitive abilities or sensory perception, or who is assembling or otherwise interacting with any embodiment of the present puzzle set in order to alleviate any medical condition for which the medical community (in the widest sense, including psychologists, therapists, social workers, or counselors) suggests puzzles to be beneficial; OR: a child or other dependent in a home setting who is assembling or otherwise interacting with any embodiment of the present puzzle set for general developmental or entertainment purposes; OR: any person assembling or otherwise interacting with any embodiment of the present puzzle set for game play and entertainment purposes.

As used herein, the term “Persons imparting knowledge” refers to Learners for the purposes of this invention shall include “Teachers”, “Proctors”, “Education Facilitators”, “Parents”, “Therapists”, “Curriculum Designers”, or any other person directly interacting with a Learner to facilitate or support the Learners' or Users' learning, therapy, developmental, and entertainment objectives, whereas the mention of a specific kind of “Person imparting knowledge” in a specific example shall be generalized to any such person in any setting. For example, mentioning a teacher facilitating a Learner obtaining an educational benefit by assembling or otherwise interacting with any embodiment of the present puzzle set shall imply Therapists facilitating a Learner or User, as defined above, obtaining a therapeutic or other medical benefit out of assembling or otherwise interacting with any embodiment of the present puzzle set. Further, mentioning a specific category of “Persons imparting knowledge”, such as a teacher, shall imply any “Person imparting knowledge” in the appropriate setting.

As used herein, the term “Content Designer” or the corresponding plural “Content Designers” shall, anywhere in this document, refer to a natural person or an algorithm designing content for any embodiment of invention presented here in the form of visual, audio, other information that can be perceived by senses, or configuration programming that determined how a Learner or User can interact with a puzzle set. In many cases, “Content Designers” will be “Persons Imparting Knowledge”, as defined above. Wherever mention is made of a specific Person Imparting Knowledge, such as a Teacher or a Therapist, it is always assumed that, at least in some embodiments of the invention, they can be a Content Designer.

As used herein, the term “Content Analysts” or the corresponding plural “Content Analysts” shall, anywhere in this document, refer to a natural person or an algorithm analyzing the interaction of a Learner or User with any embodiment of the invention, wherein the interaction is measured by sensors included in the embodiment, and the sensor data processed in such a way that it can be perceived by the Content Analyst. Sensors may include means to determine the connection between puzzle pieces and their timing, comprising the assembly timeline of any embodiment of the puzzle. Depending on the embodiment, sensors may include any input devices through which Learners or Users can interact with the corresponding embodiment through haptic means (touch), audio, or any other means. In many cases, “Content Analysts” will be the same persons or algorithms as “Content Designers”, but they may be entirely different. In many educational or therapy settings, there will be multiple “Content Analysts”, such as measuring short-term versus long-term success. Wherever mention is made of a specific Person Imparting Knowledge, such as a Teacher or a Therapist, it is always assumed that, at least in some embodiments of the invention, they can be a Content Analyst.

As used herein, the term “Correct Configuration”, “Correct Assembly”, “Correct Solution”, used interchangeably with each other, of a number of puzzle pieces defines the puzzle pieces connected in a certain relative arrangement that the Content Designer sets as a goal for the Learner to achieve as they assemble the puzzle. In some embodiments, there is a unique “Correct Configuration”, whereas in other embodiments, there are multiple “Correct Configurations”. The following terms are used interchangeably in this document: “Correct Configuration”, “Correct Assembly”, “Correct Assembly”, “Correct Way to Assemble”, and “Correct Pattern”.

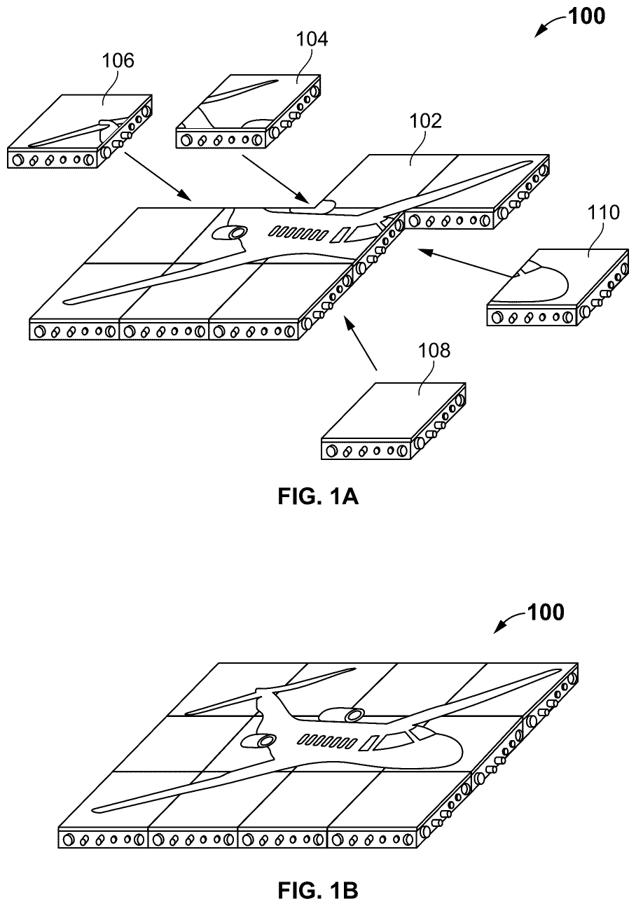

Referring to FIGS. 1A-1B, a reconfigurable puzzle 100 having a set of puzzle pieces or part of a set of puzzle pieces, during assembly and fully assembled, is disclosed. The reconfigurable puzzle 100 consisting of individual puzzle pieces (102, 104, 106, 108, and 110) with reconfigurable electronic display screens on at least one side. In FIG. TA, the majority of the puzzle set 102 is assembled, and the missing puzzle pieces (104, 106, 108, and 110) are in the process of being attached. FIG. 1B shows the configuration's unique Correct Solution. It can be generalized to images of any size by adding additional rows and columns. Notwithstanding the specific example in FIGS. 1A-1B, the scope of images to which the puzzle sets can be configured to by the Content Designer is wide, covering many applications including education, therapy, play, games, and play-based learning.

In some embodiments, the present invention includes means of connected puzzle pieces to detect the connection. In some embodiments, the present invention further includes means for the connected puzzle pieces to exchange data. The exchanged data may include the identification of the respective connected puzzle pieces through identifiers unique to one puzzle piece, and other data to be relayed to a puzzle piece, and yet other data received from a connected puzzle piece. In one embodiment, the exchanged data may include visual data for output on a display screen on a specific puzzle piece, data from sensors included on a specific puzzle piece, or any other data.

The puzzle sets are assembled by the learner or user by connecting at least two puzzle pieces along a continuous surface. In some embodiments, the surface may be two-dimensional (2D) and flat. In some embodiments, the surface may be three-dimensional (3D). In one embodiment, the reconfigurable puzzle set 100 is configured by a Content Designer such that at least one possible said continuous surface formed by attaching said puzzle set's constituent puzzle pieces is defined as a “Correct Solution”, as defined by the Content Designer, of the puzzle set. In most embodiments, the continuous surface will form continuously connected, or possibly almost continuously connected with small gaps in between, display screens that comprise a composite image. A feature of most embodiments of the invention is non-unique Correct Solutions accessible to Content Designers.

In some embodiments, the puzzle piece may be, but not limited to, a flat cuboid puzzle piece (as shown in FIG. TA) or any other shape of individual puzzle pieces. It shall cover any connection mechanism in 2D or 3D, as long as the composite images can be attached together to form a Correct Solution.

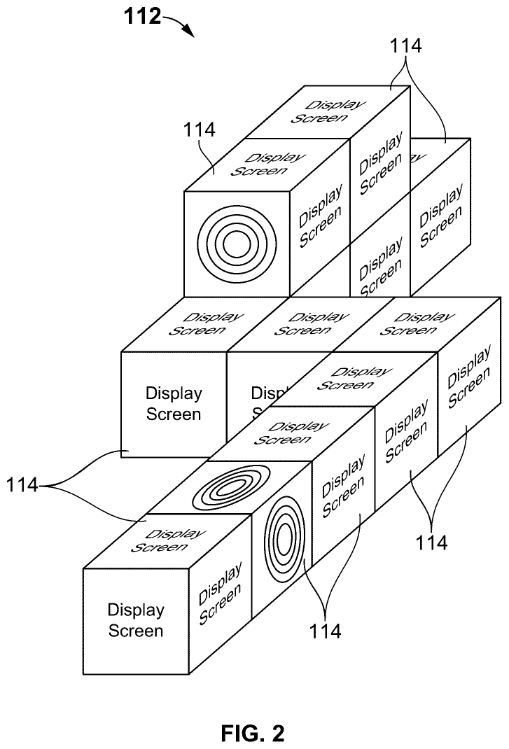

Referring to FIG. 2, a complex 3D shape 112 formed by a number of puzzle pieces 114 is illustrated. In some embodiments of both 2D or 3D capable options, the images displayed on the puzzle pieces' 114 display screens are designed by a Content Designer. The images or copies thereof are transferred to the puzzle pieces 114, and the images do not change while the users assemble the puzzle pieces or otherwise handle the puzzle pieces or the assembled puzzle set, until the Content Designer prepares and transfers a new set of images. In other embodiments, multiple images are prepared by the Content Designer and transferred to at least one puzzle piece among a puzzle set. In one embodiment, the multiple images are displayed successively in time as a series of images or as a continuous movie, or as a continuous movie segmented onto separate display screens. The latter successive display in time can either follow a predefined sequence predefined by the Content Designer or influenced through action by the users.

In one embodiment, both 3D and 2D implementations may include the display of still or moving images on display screens. In some embodiments, the 3D and 2D implementations may include input options such as touchscreens or other graphical input devices integrated with the display screens of at least one puzzle piece. The input options may include other user input sensors.

In one embodiment, the puzzle sets may contain at least one puzzle piece that includes or is connected to at least one user input sensor such as at least one touchscreen, other haptic sensor, microphone, wearable sensor, user input device, or any other sensor capable of interacting with a user. In many embodiments, the Content Designer will configure the response of output devices such as display screens, haptic output devices, and sound generating devices such as loudspeakers in response to said user input. In some embodiments, the Content Designer will further configure sensor signal processing from said at least one User input sensor.

In one embodiment, the signals from sensors such as touchscreens are processed by at least one processing unit inside the puzzle pieces. In many embodiments, the processing unit transmits control signals to the electronic display that is underneath of or integrated with the touchscreen and directs the electronic display to show patterns in response to writing or drawing motions of a finger, stylus, or tool on the touchscreen. In some embodiments or configurations, these patterns displayed may trace the writing or drawing motion on the touchscreen.

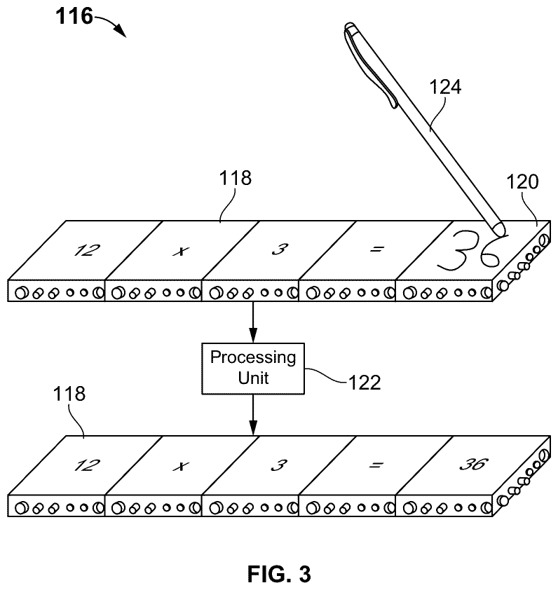

Referring to FIG. 3, a learner interacting with a flat assembled puzzle set 116 is illustrated. The flat puzzle set 116 is assembled with some or all puzzle pieces 118 equipped with touchscreens 120. In one embodiment, the puzzle piece 118 is equipped with a processing unit 122 to recognize patterns on the touchscreen 120, with a simple math problem with a non-limiting example of a stylus 124 drawing the answer to a simple math problem on the puzzle piece 118 with attached touchscreen 120.

In some embodiments, the processing unit 122 performs machine learning or artificial intelligence (ML/AI) algorithms on the touchscreen input. Depending on the embodiment or the configuration of the embodiment, the objective of the ML/AI algorithms may be classification in some embodiments/configurations and/or quantitative evaluation in other embodiments/configurations. Algorithms to interpret the touchscreen input include image classification algorithms, neural network-based algorithms for processing written symbols that can be labeled by one of a finite number of labels, or any other image recognition algorithms. In some embodiments, the labels may represent letters, numbers, logograms, hieroglyphs, geometric patterns, technical symbols such as engineering symbols, and more abstract object classifications, or any other finite set of classifications. The neural network-based algorithms include, but are not limited to, convolutional neural networks, a subset of “deep learning” neural network algorithms. Other than classification, quantitative analysis may be conducted which may include regression analysis to extract a quantitative number, or quantitative analysis may run along classification algorithms to evaluate a quality metric for symbols generated by the Users. The quality metric may contribute to grades, evaluations, or progress indicators in development, education, and therapy settings.

An example for classification algorithms applied to the user input is shown in FIG. 3, where the response to a simple math problem written on the touchscreen 120 is interpreted as a number. In some embodiments, the number corresponding to the correctly interpreted symbol may be displayed. In other embodiments, the classification interpreted by the processing Unit 122 is stored and further processed without displaying it. In other embodiments, the classification result is both stored and displayed. The processing unit 122 may be integrated in the puzzle piece 118 with the touchscreen 120, or may be integrated in another puzzle piece, or may be integrated in a system that is external to the puzzle set or partial puzzle set as shown in FIG. 3. In some embodiments, the system may be, but not limited to, a remote server, a PC, a tablet, a smartphone, a mobile phone, a laptop, or other computing device exchanging data with the puzzle set 116.

In some embodiments, AI/ML algorithms are utilized for image interpretation schemes of touchscreen inputs, that are much broader than classification schemes. In some embodiments, puzzle sets 116 may contain at least one puzzle piece 118 that contains a haptic feedback mechanism on at least one surface of the puzzle piece 118. In most of the latter embodiments, the Content Editor is able to configure, in response to input from the touchscreen; or other sensors; or following a time sequence; or input from the user, the output of the haptic feedback actuator; or the display on at least one display screen on at least one puzzle piece; or any other output or data transmission to an external device that can be initiated by at least one puzzle piece.

All embodiments of the invention allow means for data transmission to the puzzle pieces comprising a puzzle set, and many embodiments allow means of retrieving other data from at least one puzzle pieces in the puzzle set. To facilitate the data transmission and the retrieval of other data, at least one puzzle piece is connected to an external data transmitting device through a wired or wireless connection.

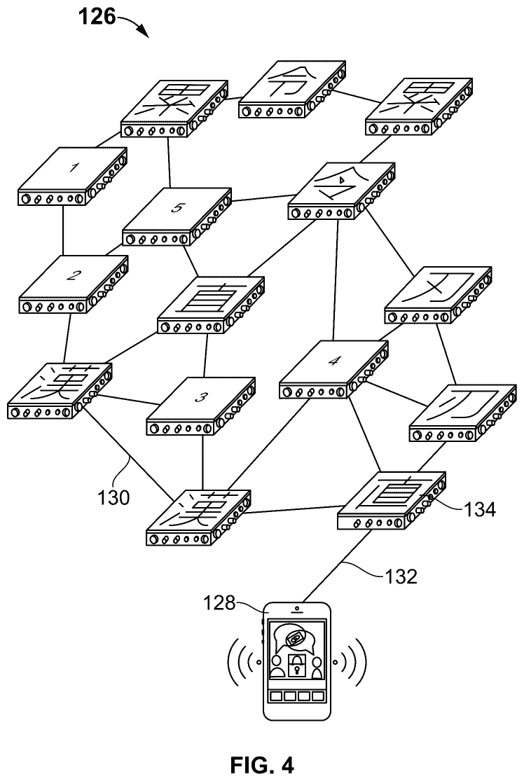

Referring to FIG. 4, a peer meshed network 126 of puzzle pieces interacting with an external device or user device 128 is illustrated. In one embodiment, the puzzle pieces comprising a puzzle set are connected among each other through a peer-to-peer wireless network 130. In one embodiment, the wireless network 130 may be, but not limited to, a radio frequency (RF) mesh network such as Bluetooth, Bluetooth Low Energy (BLE), Zigbee, Z-wave, Thread, or any other radio frequency protocol. The wireless network 130 permits distribution of data transmission to, and retrieving of other data from, any puzzle piece through the wireless network 130. In one embodiment, one puzzle piece is connected to the user device 128 via another wireless connection or wired connection 132. The user device 128 may be a portable device such as a smartphone, tablet, or laptop; or a stationary device such as a desktop computer. The another wireless connection 132 may be facilitated by an RF-based protocol such as Bluetooth or WiFi, either directly from the user device 128 to the one puzzle piece, or through another wireless connection 132 which the user device 128 and the one puzzle piece participate in, such as a WiFi network. The another wireless connection 132 takes place through a WiFi router, hub, or switch. In some embodiments, the another wireless connection 132 may be part of the wireless network 130, which the user device 128 may participate in as a peer device.

In one embodiment, the user device 128 is connected to one puzzle piece 134 through the another wireless connection 132. The one puzzle piece 134 may be selected from a privileged class of at least one puzzle pieces among a set which are equipped with means to communicate with the user device 128. In some embodiments, a typical case may be a limited number of puzzle pieces that are equipped with WiFi, if the another wireless connection 132 is a WiFi connection. In other embodiment, any puzzle piece is equipped with the means to communicate with the user device 128, and the another wireless connection 132 communicates with is selected in an ad-hoc manner, such as the first puzzle piece detected, or the puzzle piece that appears to show the strongest connection, through random selection, or through other criteria. A typical case in which the puzzle piece showing the highest quality connection with the user device 128 is selected for communication through the another wireless connection 132 may be given if both the peer wireless network 130 and the another wireless connection 132 are based on Bluetooth- and/or BLE protocols.

In one preferred embodiment, the user device 128 connects to one puzzle piece 134 through a wired connection in essence, the another wireless connection 132 is then a wired interface, while the peer network 130 is still the same wireless network as described above.

A specific variation of the latter is a wired interface from the user device 128 that is compatible with and mates with one of the connectors normally used to connect puzzle pieces together, referred to as “inter-piece connector”. In a preferred embodiment, such a wired interface may include a cable with an inter-piece connector on the puzzle piece and a connector that is widely available on user devices on the user device end, such as a USB interface. In some embodiments, multiple connectors may be available on the user device end of the wired interface, such as different variations of USB connectors or proprietary connectors for some brands of smartphones or other mobile devices, such as the Apple ecosystem. In addition to the inter-piece connector and the user device connector, the wired interface may further include circuitry that converts data transmission formats among the connectors, such as from USB to UART or any other data exchange format used by the data pins of the inter-piece connector.

In terms of the network topology shown in FIG. 4, a wired connection 132 essentially integrates one puzzle piece which is identical or substantially similar to the other puzzle pieces in the set connected in network 130 with the user device 128, such as a smartphone, tablet, laptop, or desktop computer. In that case, the puzzle piece 134 connected to the user device 128 performs the function of an interface module for data transmission and retrieval of other data with the puzzle set. In some embodiments, the puzzle piece integrated in the user device 128 may be selected from a privileged class of at least one puzzle pieces among a set which is configured to act as an interface module, and/or be equipped with more powerful RF transmission capabilities or greater memory. In other embodiments, any puzzle piece from the set can be thus integrated with the user device 128.

In many of the embodiments in which the data connection 132 is a wired connection, that connection also serves to recharge batteries in the pieces of the entire puzzle set if all the pieces in the set are connected.

In some embodiments, the user can transmit data to any puzzle piece in the network 130 through the another wired or wireless connection 132, wherein the data is further transmitted to the respective target puzzle piece through the peer wireless network 130. The data transmission can include requests for retrieving data, or “polls”, from any puzzle piece. The User can also retrieve other data from any puzzle piece, wherein any puzzle piece transmits data through the peer wireless network, which proceeds through the another wireless connection 132 to the user device 128.

In some embodiments, the wireless network 130 is replaced by a fully wired network which is formed when the puzzle pieces in a set are connected together through wired connections, if the wired connections allow for the exchange of data among connected puzzle pieces. In case network 130 is wired, the User device may still be connected to the one puzzle piece 134 through connection 132 through a wireless RF connection, or the connection 132 may be wired as well, either through a wired data connection such as USB to the select puzzle piece, or through an interface device connected to the User device, wherein the interface device includes a connector compatible with the wired connections between puzzle pieces, and is able to exchange data through the latter connector interface. The invention shall cover any embodiment that allows for a data transmitting device to transmit data addressed to any puzzle piece which is part of a puzzle set.

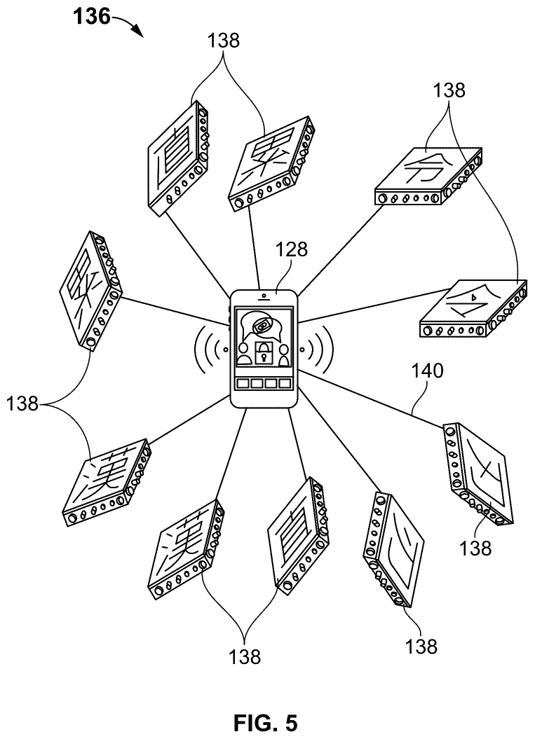

Referring to FIG. 5, a centralized network of puzzle set 136 interacting with an external device 128 is illustrated. In some embodiments, alternatives to the peer network architecture shown in FIG. 4 are networks in which a data transmitting device acts as a central hub which is wirelessly connected to all puzzle pieces comprising a puzzle set. An example embodiment of the latter is shown in FIG. 5, where all puzzle pieces 138 in a puzzle set 136 are connected to the user device 128 through wireless connections 140. The user device 128 either contains or includes a data transmitting device. Examples of the user device 128 include, but are not limited to, smartphones, tablets, laptops, or desktop computer, which are connected to a transmitting device capable of generating the wireless protocol that the wireless connection 140 relies on. Preferred examples for wireless protocols are RF protocols, e.g., WiFi, Bluetooth, BLE, Zigbee, Z-wave, Thread, or any wireless communications systems that enable one hub to transmit data to more than one device shall constitute a valid wireless protocol 140.

In some embodiment, the centralized networks shown in FIG. 5 allow for the retrieval of data from at least one of the puzzle pieces in the puzzle set 136, through the wireless channel 140 to the user device 128. The wireless communications protocols for the data transmission to and the data retrieval from the puzzle piece may be the same, or they may be different, but will be chosen from the same selection of protocols.

Embodiments of the invention include modifications of the embodiments shown in FIG. 4 or FIG. 5, wherein the user device 128 is not co-located or integrated with the data transmitting device, but communicates with the data transmitting device over a distance through a wired or wireless connection, or connects to the data transmitting device through at least one data relay through wired and/or wireless connections. One example may be a dedicated communications hub in lieu of the User devices in FIGS. 4 and 5, which may be connected to the user device 128 through at least one network connection, which may include or be comprised by a WiFi network, a wired Ethernet network, or the World Wide Web, wherein the User device may include, but will not be limited to, a smartphone, tablet, laptop, or desktop computer. In yet other embodiments, the user device 128 may be comprised by a software program running on a computer without human interference, wherein the software program determines which Content (Content Designer) or data are transmitted to the puzzle set, and wherein the software program may receive and Analyze (Content Analyst) or process data retrieved from the puzzle set.

In some embodiments, more than one data transmitting devices may communicate with the puzzle set, for example, one data transmitting device which is designed for greater bandwidths for larger files, and a second data transmitting device which is optimized for human user interaction to send control signals and commands to the puzzle set.

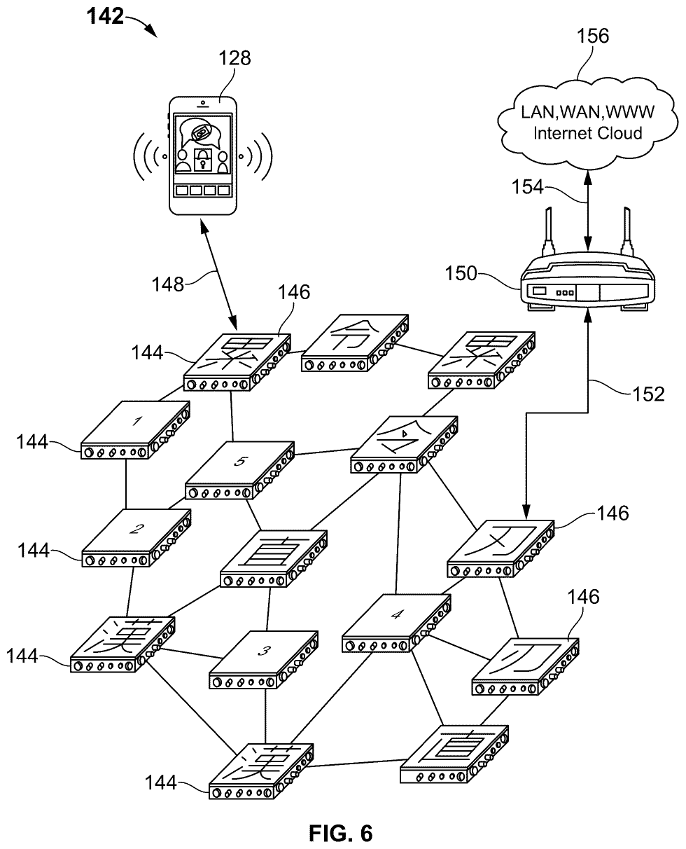

Referring to FIG. 6, a peer meshed network 142 of puzzle pieces interacting with more than one external devices is illustrated. In a preferred embodiment, the puzzle pieces 146 are connected through a wireless mesh network 142 for redistribution of data among the puzzle pieces 146 similar to FIG. 4. In one embodiment, the puzzle set 144 is connected to one data transmitting device or a user device 128. The user device 128 may include, but not be limited to, a smartphone, tablet, laptop, or desktop computer. The connection between the puzzle set 144 and the user device 128 may be facilitated by a wireless connection 148, to be selected from among the same protocols as the embodiments shown in FIG. 4. The puzzle set 144 may be connected to a second data transmission device 150. In one embodiment, the second data transmission device 150 may be, but not limited to, a WiFi router, switch, or hub, which is connected to at least one puzzle piece 146 through a wireless connection 152. The second data transmission device 150 may be connected to at least one other device through a wired or wireless connection 154. The one other device may be connected through a network 156 such as a local area network (LAN), wide area network (WAN), the world wide web (WWW), the internet, or the “cloud”. The user device 128 may, or may not, be directly or indirectly connected to the same network 156.

A typical configuration for an embodiment shown in FIG. 6 is as follows: the user device 128 transmits commands to at least one puzzle piece 146 to download data, which may include images, movies, sound files, or configuration data, through a WiFi router 150. In one embodiment, the router 150 is connected to at least one puzzle piece 146. Upon learners or users interacting with at least one puzzle piece, data generated by the interaction may be transmitted to the user device 128 through the connection 148, and/or to the router 150 through the connection 152. Some interactions with puzzle pieces result in low-bandwidth data, such as two puzzle pieces detecting being connected, or a user creating a low-complexity input on the touchscreen (for embodiments in which a touchscreen is included in at least one puzzle piece). These will be preferentially transmitted to the user device 128. Other interactions, such as more complex input generated on a touchscreen or audio files recorded (in case a touchscreen and/or sound recording device is included in at least one puzzle piece), will be preferentially retrieved from puzzle pieces through the higher-bandwidth connection 152. In some embodiments, data may be transmitted to both the User device and the higher-bandwidth connection 152.

For embodiments in which at least one puzzle piece contains sensors that generate a significant amount of raw data, such as sound-recording devices or touchscreens, some processing of the sensor data will be conducted by a processing unit integrated in the puzzle piece, wherein the preprocessed data require significantly less storage than the raw data, wherein the preprocessed data may get retrieved from the puzzle piece by a data transmitting device from the processing units in the puzzle pieces via a wireless peer network connection. The preprocessed data may include edge processed data. In some embodiments, most or all of the processing of some data will be conducted in the puzzle piece. Partial or complete processing of data in a portable or mobile device such as a puzzle piece is in the Internet of Things (IoT) technology domain referred to as Edge Processing. Such preprocessing may comprise reducing resolutions of characters drawn on touchscreens, decoding symbols written through handwriting recognition algorithms, removing noise from recorded audio files, or decoding audio files. However, in some embodiments, no preprocessing may be conducted, and the raw data may be forwarded directly to a data transmitting device.

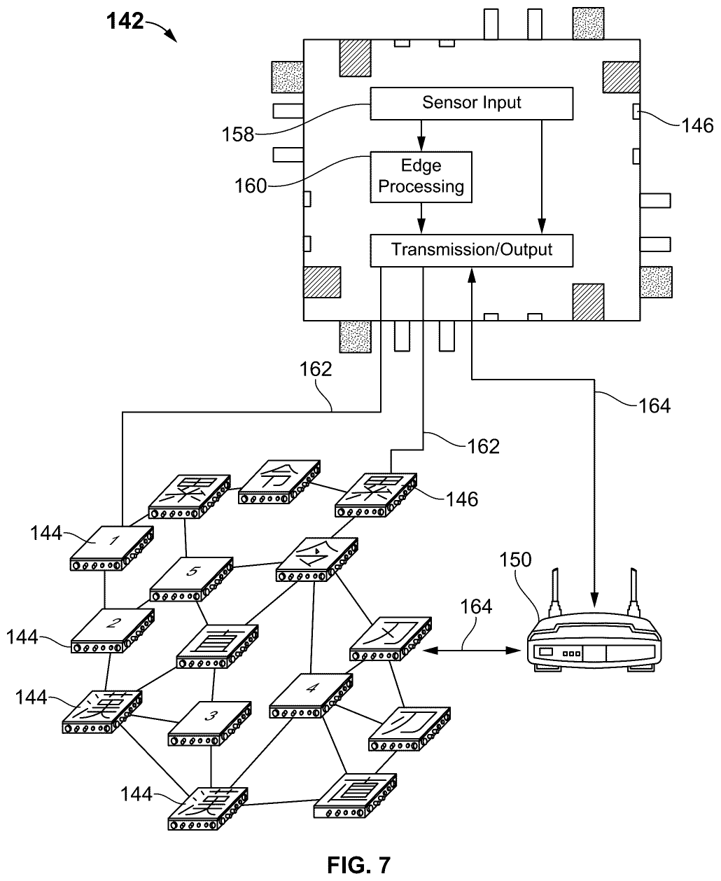

Referring to FIG. 7, a schematic diagram of wireless peer network 142 with partial edge processing inside a puzzle piece 146 is illustrated. In a preferred example embodiment of a puzzle set 144, in which the puzzle pieces 146 are connected through a peer mesh network 142, in which at least one puzzle piece 146 contains a sensor input 158 such as at least one touchscreen, at least one audio-recording device, or any other sensor input. In one embodiment, some of the raw data from the sensor input is processed in an Edge Processing step 160, using a processing unit integrated in the puzzle piece 146. In one embodiment, the data resulting from the edge processing 160 may be transmitted through the wireless peer network connections 162. In another embodiment, the data resulting from the edge processing 160 may be output through a display screen, through a sound-generating device, or through other means of output integrated in the puzzle piece 146. In one embodiment, some raw data that is not processed through edge processing may be transmitted through wireless peer network connections 162. In another embodiment, output through a display screen, a sound-generating device, of any other means of output integrated in the puzzle piece 146. Data transmitted through the wireless connections 162 may be retrieved from the puzzle set 144 via other wireless connections 164, which connect the puzzle set 144 with a data transmitting device 150. The data transmitting device 150 may be a data hub, such as a WiFi router or any other wireless networking device, or a user device which includes or is connected to a device capable of communicating through any wireless communication protocol, for example RF protocols such as WiFi, Bluetooth, BLE, Zigbee, Z-wave, or Thread.

In some embodiments, the wireless peer mesh network is replaced by a wired network, so that the connections 162 also take place through a wired connection, such as data connections through inter-piece connectors among connected puzzle pieces. In those embodiments, the other connections 164 may also be comprised by a wired connection, such as an interface connector compatible with the inter-puzzle connectors, or any other wired connection such as USB.

In one embodiment, the processing unit in the puzzle pieces, such as the processing unit performing the Edge Processing, may be a microcontroller which would be manufactured most cost-effectively now, such as an ARM compatible microcontroller, or compatible with another ecosystem such as an Espressif or Microchip microcontroller. However, with ongoing miniaturization and reduced cost for a given amount of processing power, it is understood that puzzle pieces with CPUs such as those used today in personal computers, graphical processing units (GPUs), or processors with reconfigurable logic blocks such as field-programmable gate arrays (FPGAs) or hybrid microcontroller-FPGA architectures may, in the near future, be manufacturable at reasonable cost, so that the patent shall also cover embodiments with those processing units. Further, more application-specific processors originally designed for other purposes, such as digital signal processing systems (DSPs) may be repurposed for the puzzle pieces.

In some embodiments, the data transmitting devices 150 external to the puzzle set 144 serve as conduits for the transmission of content generated by the Content Designer on a Content Engine to the puzzle pieces, as well as conduits for sensor input, or processed sensor input data, to be retrieved from the puzzle pieces and transmitted to a Content Analysis Engine to be analyzed by a Content Analyst.

A Content Engine is any device or system, whether automated or operated by humans, that generates content to be transmitted to the puzzle set, and may include any or all of the following: (i) one or multiple images to be displayed per puzzle piece, on at least one display screen per puzzle piece, on at least one puzzle piece; (ii) sound files to be played through a sound-generating device, if such is integrated in at least one puzzle piece; (iii) instruction or configuration files to control haptic feedback mechanisms, if such are integrated in at least one puzzle piece; (iv) any other files that contain data to affect any other device output; (v) program- or configuration files to instruct the processing units integrated in the puzzle pieces on which data are output through output devices, either in a time sequence or in response to inputs from Learners or Therapy Patients or Clients; (vi) any other data necessary to properly configure any of the embodiments covered by this invention.

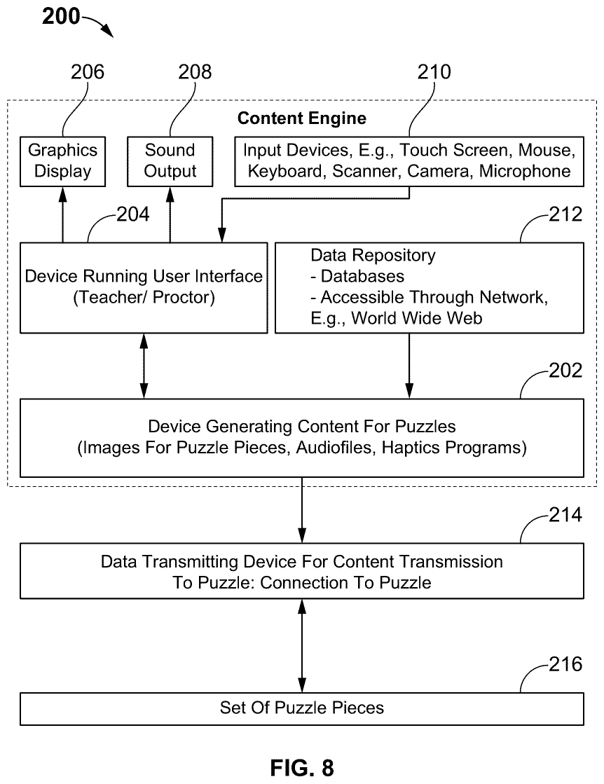

Referring to FIG. 8, a block diagram of a system of cloud-based Content Engine 200 for a puzzle set is illustrated. Typically, a computing device or content generating device 202 generating the content is a physical or virtual server for remote operation, running in at least one data center, such as operated by commercial cloud services companies such as Amazon Web Services or Microsoft Azure, or in an in-house, proprietary data center. The content generating device 202 is controlled by another device running a user interface or another device 204. An another device or second device 204 communicates with the content generating device 202 through at least one networked connection. The at least one networked connection may include local area networks and the world wide web or internet. The Content Designer, such as a teacher, proctor, parent, or therapist, or another person, operates the content generating device 202 through the another device 204.

Typically, the another device 204 will be a laptop or desktop computer, tablet, or smartphone, or any computing device with similar capabilities and compatible data interfaces, with integrated or connected graphics output 206 and optional sound output 208 to preview any visual and optional audio content designed. The Content Designer uses at least one input devices 210. The input device 210 may include a touchscreen, mouse, keyboard, scanner, camera, or microphone, to help design the content. Many input devices will be directly connected to another device 204, however, some input devices, such as a microphone or camera, may also be connected to a third device (not shown in FIG. 8). In one embodiment, image, movie, or sound files will be recorded at an earlier time prior to being transferred onto the another device 204. A data repository 212 with databases of content accessible through a network such as the World Wide Web may also be accessible from device 202, where content compatible to the puzzle pieces can be retrieved after initiation by a program running on device 202 or by a Content Designer operating device 204. From device 202, the content is transferred through at least one data network, which may include the world wide web and one or more local networks, to the data transmitting device 214, from where it proceeds to the set of puzzle pieces 216 described elsewhere in this document.

A Content Analysis Engine is any device or system, whether fully automated or partially operated by humans, that receives and analyzes sensor data retrieved from at least one puzzle piece from among a puzzle set, wherein the sensor data may be any combination of raw data and data partially or fully processed in an “Edge Processing” step within at least one of the puzzle pieces, and wherein the sensor data is generated by Learners or Therapy Patients or Clients interacting with any or all of the input devices integrated in at least one puzzle piece, for example a touchscreen, a sound recording device such as a microphone, data generated by puzzle pieces being connected together, or any other sensor data actuated by persons interacting with, or using the puzzle set. Analysis of the sensor data in the Content Analysis Engine may encompass any algorithms, including artificial intelligence/machine learning algorithms, that quantitatively measure the performance and progress in the Learner or Therapy Patient or Client assembling the puzzle set and, in embodiments in which at least one puzzle piece contains input devices, progress in completing a learning goal by interacting with the input devices during or after assembling the puzzle set. The Content Analysis Engine is operated by a Content Analyst, either interactively, or after an automated algorithm has completed an automated analysis.

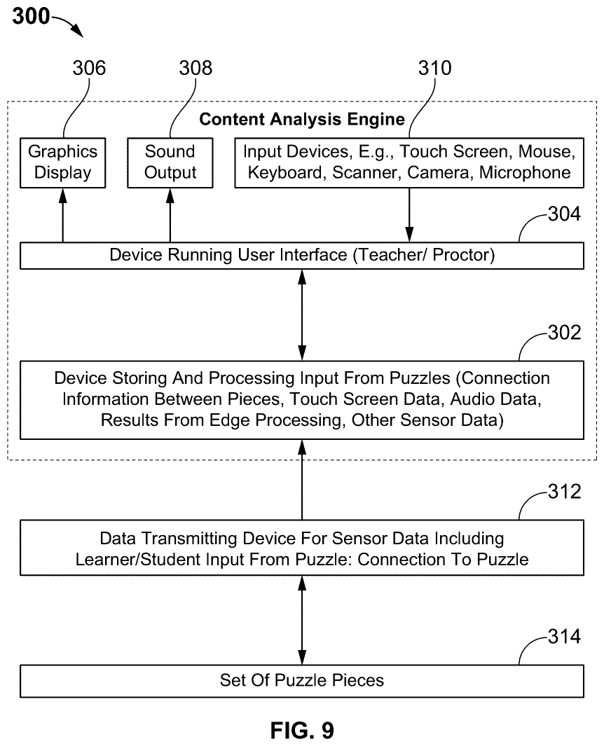

Referring to FIG. 9, a block diagram of a system of cloud-based Content Analysis Engine 300 for a puzzle set is illustrated. The cloud-based Content Analysis Engine 300 comprises a device 302 that stores and processes input data from puzzles. The input data may include, but is not limited to, connection information between puzzle pieces, touchscreen data, audio data, other sensor data, and results from partial edge processing. Typically, the device 302 is a physical or virtual server for remote operation, running in at least one data center, such as operated by commercial cloud service companies such as Amazon Web Services or Microsoft Azure, or in an in-house, proprietary data center. The device 302 is connected to another device 304 running a user interface, which communicates with device 302 through at least one networked connection, which may include local area networks and the world wide web or internet. The Content Analyst, such as a teacher, proctor, parent, or therapist, operates the device 302 through the another device 304, and initiates, conducts, or verifies the data analysis on device 302.

Typically, the another device 304 will be a laptop or desktop computer, tablet, or smartphone, or any computing device with similar capabilities and compatible data interfaces, with integrated or connected graphics output 306 and optional sound output 308 to review any raw or processed data from the puzzle set. The Content Analyst uses at least one input devices 310, which may include a touchscreen, mouse, keyboard, scanner, camera, or microphone, to help analyze the content. The cloud device 302 receives data retrieved from the puzzle set through at least one data network, which may include the world wide web and one or more local networks, from the data transmitting device 312, which, in turn retrieves it from the puzzle set 314 described elsewhere in this document.

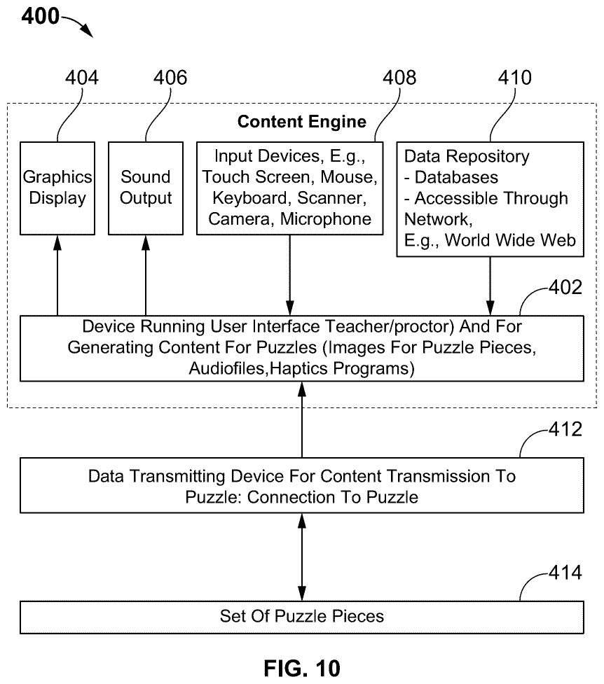

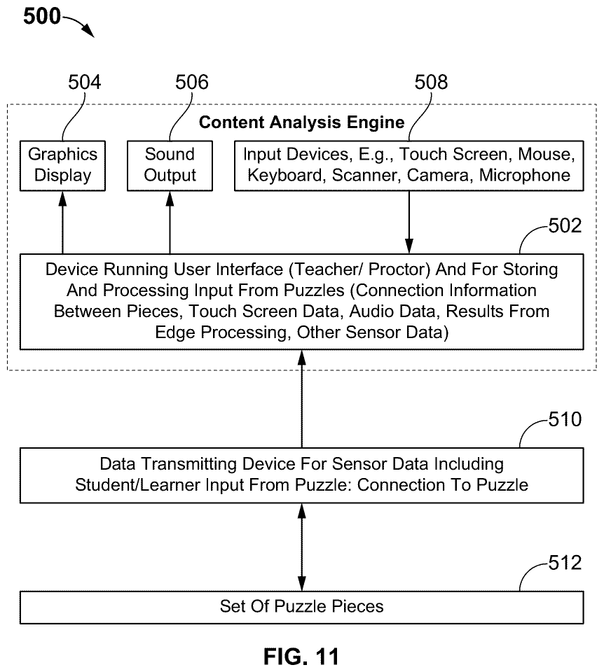

FIGS. 10 and 11, respectively, show embodiments of a Content Engine and Content Analysis Engine that rely on local user devices rather than computing devices running in the cloud, as shown in FIGS. 8 and 9. However, in both the local (FIGS. 10 and 11) and cloud-based (FIGS. 8 and 9) embodiments, the Content Engines and Content Analysis Engines may share part or all of the same hardware, or may be an identical system operated using different configurations.

Referring to FIG. 10, a block diagram of a system of local Content Engine 400 for a puzzle set is illustrated. The local Content Engine 400 generates content within the same scope as the embodiment in FIG. 8. The Content Designer directly interacts with the computing device 402 that also generates content for the puzzle sets. The device 402 is typically a laptop or desktop computer, tablet, or smartphone, or any computing device with similar capabilities and compatible data interfaces, with integrated or connected graphics output 404 and optional sound output 406 to preview any content designed. The Content Designer uses at least one input devices 408, which may include a touchscreen, mouse, keyboard, scanner, camera, or microphone, to help design the content. Many input devices will be directly connected to device 402, however, some input devices, such as a microphone or camera, may also be connected to a third device (not shown in FIG. 10), wherein the image, movie, or sound files will be recorded at an earlier time prior to being transferred onto device 402. A data repository 410 with databases of content accessible through a network such as the World Wide Web may also be accessible from device 402. Any content designed or prepared will be transferred from device 402 through at least one data network to the data transmitting device 412, from where it proceeds to the set of puzzle pieces 414 as described elsewhere in this document.

Referring to FIG. 11, a block diagram of a system of local Content Analysis Engine 500 for a puzzle set is illustrated. The local Content Analysis Engine 500 performs functions within the same scope as the embodiment in FIG. 9. The Content Analyst directly interacts with the computing device 502 that also stores and processes content retrieved from the set of puzzle pieces. The device 502 is typically a laptop or desktop computer, tablet, or smartphone, or any computing device with similar capabilities and compatible data interfaces, with integrated or connected graphics output 504 and optional sound output 506 to preview any content designed. The Content Analyst uses at least one input devices 508, which may include a touchscreen, mouse, keyboard, scanner, camera, or microphone, to assist in analyzing the content. The device 502 receives data retrieved from the puzzle set through at least one data network from the data transmitting device 510, which, in turn retrieves it from the puzzle set 512 as described elsewhere in this document.

In some embodiments, the Content Engine delivers data to the puzzle set following a curriculum that follows a schedule preset in time, or that is dependent on analysis results of data retrieved from the puzzle set, wherein the data was generated by Learners or Therapy Patients or Clients interacting with at least one puzzle piece.

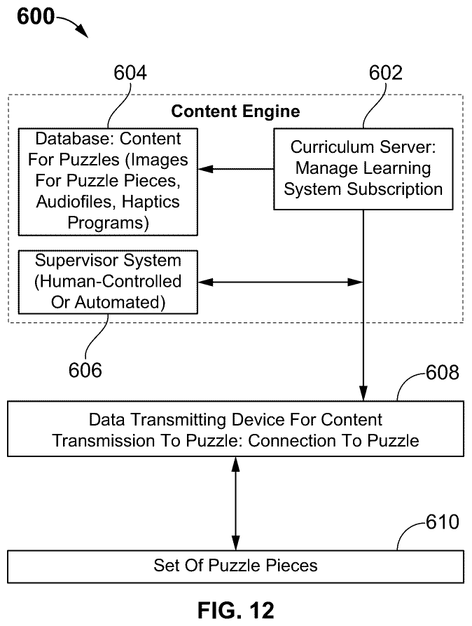

Referring to FIG. 12, a block diagram of a system of Content Engine 600 with automated curriculum delivery for a puzzle set is illustrated. The Content Engine 600 delivers a subscription to curriculum content to a puzzle piece. A curriculum server 602 manages the subscription and delivers content to the puzzle set, wherein the content may be retrieved from a database 604 which contains data to be delivered that may include images or series of images such as movies, audio files, haptics programs, any other data output for at least one puzzle pieces, and programs and configuration files for at least one puzzle pieces. The progress of the curriculum delivered is supervised through a human-controlled or automated monitoring system 606. From curriculum server 602, the content is transferred through at least one data network, which may include the world wide web and one or more local networks, to the data transmitting device 608, from where it proceeds to the set of puzzle pieces 610 as demonstrated in embodiments described in this document. The implementation of the curriculum server may be a physical or virtual server for remote operation, running in at least one data center, such as operated by commercial cloud services companies such as Amazon Web Services or Microsoft Azure, or in an in-house, proprietary data center, or as a server on a local area network or otherwise connected to the data transmitting device 608.

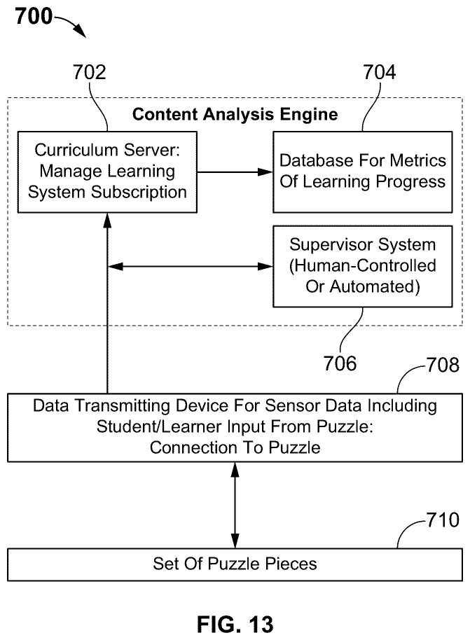

Referring to FIG. 13, a block diagram of a system of Content Analysis Engine 700 with automated curriculum analysis for a puzzle set is illustrated. In an automated curriculum setting, the Content Analysis Engine 700 retrieves data from a puzzle set following a schedule preset in time, or that is dependent on analysis results of data retrieved from the puzzle set. The content analysis engine 700 comprises a curriculum server 702 that performs analysis on data retrieved from a puzzle set within the same or similar scope as described with the embodiment in FIG. 9 or 11. Some or all of the analysis may be saved in a database 704 which may track metrics for learning progress or other progress reports following the curriculum. The data retrieved from the puzzle set may be supervised through a human-controlled or automated supervisor system 706. The device 702 retrieves data from the puzzle set through at least one data network from the data transmitting device 708, which, in turn retrieves it from the puzzle set 710 as described in the embodiments elsewhere in this document.

One challenge in remote formal or informal education where learners or therapy patients or clients are located at a distance from the Content Designer, or any person supervising the learners or therapy patients or clients, is the verification that work has actually been performed by any specific learner or therapy patients or clients, as well as assigning a quantitative metric describing the quality of work conducted by learners or therapy patients or clients. While, in more formal education settings, remote exams are oftentimes well established today, there is no feasible method to obtain a “participation score” if learners or therapy patients or clients are distributed across different location and communicate with teachers through a remote network connection. “Participation scores” are customary in many education settings and are oftentimes based on teachers' evaluation of learners' or therapy patients' or clients' progress during every-day tasks performed when teachers, therapists, and others as well as learners or therapy patients or clients are present in the same location. Oftentimes, Participation scores form part of an overall grade, and/or serve to inform the teacher, therapist, or person in a similar position on the curriculum progress of learners or therapy patients or clients prior to examinations or analyzing therapy progress in a remote therapy setting.

Embodiments of the invention can be used to verify the participation of learners or therapy patients or clients in remote settings on work that is conducted with a puzzle set. Since the subject matters that can be covered by the puzzle sets, as described in the embodiments shown and similar embodiments, can cover a considerable part of many education curricula or therapy treatment plans, the reconfigurable puzzle sets can thus serve as valuable tools that help teachers, or other persons imparting knowledge, or therapists, to obtain a Participation score in remote education settings, along with a verified quality score. Any of the embodiments of Content Designers and Content Analysis Engines shown in FIGS. 8-13 can be enhanced by algorithms that track and record the learning or therapy progress within the puzzle sets or in computing devices connected to the puzzle sets, encode the progress through encryption algorithms to conserve privacy, and transmit the progress report through the data transmitting device to the Content Analysis Engine for further evaluation.

To avoid falsification of Participation scores, some embodiments include algorithms that track the progress in a shared, immutable ledger such as a public or private Blockchain with an appropriately designed Smart Contract that ensures that (i) remote work with the puzzle sets is tracked, (ii) learners or therapy patients or clients receive objective credit for any work conducted or therapy progress, (iii) privacy is conserved, since the identity of individual learners or therapy patients is anonymous to any unauthorized persons, even in public blockchains, and (iv) learners or caregivers of learners, or therapy patients, are given the possibility to veto the sharing of any content recorded or data acquired in the home.

In some embodiments, a method includes some or all of the following features: segmenting a digital image that can cover a surface into a set of sub-images using a first processing unit with attached program memory to execute the segmentation program and data memory to store images, transmitting the sub-images, along with meta-data indicating the position of the sub-images within the overall image and other information related to the image, to a set of second processing units referred to as a set of puzzle components. Each sub-image is transmitted to one puzzle component with: (i) attached data memory where the image is stored, (ii) attached at least one display screens where the sub-image is displayed, (iii) attached program memory which executes a set of instructions that control the display of sub-images on the display screens, (iv) attached connectors that permit puzzle components forming mechanical connections that result in an alignment of display screens belonging to different puzzle components, such that display screens of thus connected puzzle components form part of a composite image.

In one embodiment, at least one puzzle component is attached to at least one sensor that permits user input, such as a haptic feedback sensor such as a touchscreen, or a voice feedback sensor such as a microphone with attached audio processor. The method further includes assembling two or more among the puzzle components together using the attached connectors such that their aligned display screens comprise composite images. The assembly of the composite images has been evidenced to support educational, medical, therapeutic, or entertainment goals of the person assembling. Each puzzle component identifies which other puzzle component it is attached to through a connector. The person assembling the components interact with the at least one puzzle component with attached user feedback sensor with the interaction resulting in a modified image displayed on at least one display screen of any puzzle component,

Until all puzzle components are assembled together, the puzzle components generate a positive feedback signal if the original image that can cover a surface is recovered, or another configuration that is set as another correct solution of the puzzle as defined by the metadata received by the puzzle components, or otherwise the puzzle components generate a negative feedback signal if not connected according to one of the correct solutions. In one embodiment, a person interacts with the assembled puzzle components through the user input sensors attached to the at least one puzzle component with attached user feedback sensor with the interaction resulting in a modified image displayed on at least one display screen of any puzzle component.

In some embodiments, a method also includes some or all of the following features: for a specific client in a therapy setting, education setting, or developmental setting, determine a least one customized image and a customized segmentation of the at least one image that will yield a positive therapeutic, educational, or developmental result when reassembled by, and calibrated to, the individual client, segmenting the at least one customized image into a set of sub-images following the customized segmentation using a first processing unit with attached program memory to execute the segmentation program and data memory to store multiple images, and transmitting the sub-images, along with meta-data indicating the position of the sub-images within the overall image and other information related to the image, to a set of second processing units referred to as a set of puzzle components. Each sub-image is transmitted to one puzzle component with: (i) attached data memory where the image is stored, (ii) attached at least one display screens where the sub-image is displayed, (iii) attached program memory which executes a set of instructions that control the display of sub-images on the display screens, (iv) attached connectors that permit puzzle components forming mechanical connections that result in an alignment of display screens belonging to different puzzle components, such that display screens of thus connected puzzle components form part of a composite image.

In one embodiment, at least one puzzle component is attached to at least one sensor that permits user input, such as a haptic feedback sensor such as a touchscreen, or a voice feedback sensor such as a microphone with attached audio processor. The specific client assembling two or more among the puzzle components together using the attached connectors such that their aligned display screens comprise composite images. The assembly of the composite images has been evidenced to support educational, medical, therapeutic, or developmental goals of the specific client assembling. Each puzzle component identifies which other puzzle component it is attached to through a connector. The specific client assembling the components interacts with the at least one puzzle component with attached user feedback sensor with the interaction resulting in a modified image displayed on at least one display screen of any puzzle component.

Until the specific client has assembled all puzzle components together, the puzzle components generate a positive feedback signal if the original image that can cover a surface is recovered, or another configuration that is set as another correct solution of the puzzle as defined by the metadata received by the puzzle components, or otherwise the puzzle components generate a negative feedback signal if not connected according to one of the correct solutions. The specific client interacts with the assembled puzzle components through the user input sensors attached to the at least one puzzle component with attached user feedback sensor with the interaction resulting in a modified image displayed on at least one display screen of any puzzle component.

In some embodiments, a method further includes some or all of the following features: (a) for a group of at least one client in an education, therapy, or developmental setting, determine a series of customized themes depicted as images and a series of customized segmentations of the images that benefit the group's goals for education, therapy, or developmental settings following established quantitative and evidence-based methods on the education, therapy, or developmental field, when members of the group assemble the customized segmented images into a whole image, (b) using a first processing unit with attached program memory to execute a segmentation program, segmenting one image from among the series of customized images into a set of sub-images according to the segmentation corresponding to the one image out of the series of segmentations, wherein all images are stored on data memory attached to the first processing unit, (c) transmitting the sub-images, along with meta-data indicating the position of the sub-images within the overall image and other information related to the image, to a set of second processing units referred to as a set of puzzle components, wherein each sub-image is transmitted to one puzzle component of the set of puzzle components with: (i) attached data memory where the image is stored, (ii) attached at least one display screens where the sub-image is displayed, (iii) attached program memory which executes a set of instructions that control the display of sub-images on the display screens, (iv) attached connectors that permit puzzle components forming mechanical connections that result in an alignment of display screens belonging to different puzzle components, such that display screens of thus connected puzzle components form part of a composite image.

In one embodiment, at least one puzzle component is attached to at least one sensor that permits user input, such as a haptic feedback sensor such as a touchscreen, or a voice feedback sensor such as a microphone with attached audio processor. A person from among the group of at least one client or customer defined in (a) assembling two or more from among the puzzle components together using the attached connectors such that their aligned display screens comprise composite images, wherein each puzzle component identifies which other puzzle component it is attached to through a connector. The timing of puzzle components assembled together is recorded, wherein the time record of assemblies and dis-assemblies of pair-wise puzzle components is saved in a data memory, resulting in an assembly record. The person, while assembling the components, interacts with the at least one puzzle component with attached user feedback sensor with the data generated by the interaction processed in a processing unit and the results of the processing recorded in a data memory, resulting in a feedback record.

The puzzle components generate a positive feedback signal if all puzzle components are assembled together and the original segmented image from step (b) is recovered, or another configuration that is set as another correct solution of the puzzle as defined by the metadata received by the puzzle components is recovered, or otherwise the puzzle components generate a negative feedback signal if all puzzle components are connected together but are not connected according to one of the correct solutions. The positive and negative feedback signals are recorded in memory and analyzed, resulting in a quantitative completion record. The quantitative completion record and the assembly record and the feedback record are continuously analyzed, resulting in at least one continuously updated quantitative proficiency score that evaluates the adequacy of the level of difficulty the assembling person encountered when assembling the puzzle pieces together, and also resulting in a quantitative exit score that measures the amount of exposure the person has completed to a specific segmented image defied in (b).

The exit score is compared with a predetermined threshold and, once the exit score exceeds the threshold, the quantitative proficiency score is evaluated and, if the quantitative proficiency score is below a second predetermined threshold, modify the series of customized themes depicted as images in (a) towards images that are easier to assemble when segmented, or the series of customized segmentations in (a) towards a lower number of segments, and, if the quantitative proficiency score is above a second predetermined threshold, modify the series of customized themes depicted as images in (a) towards images that are more challenging to assemble when segmented, or the series of customized segmentations in (a) towards a greater number of segments, (j) repeat step (b) with the next image and corresponding segmentation.

In some embodiments, a method further includes some or all of the following features: transmitting regularly or irregularly tiled segments comprising at least one image from a first data memory attached to a first processing unit to a second data memory attached to a second processing unit via a first data connection comprising at least one wired or wireless data network. The wired or wireless data network may include, but not limited to, a local area network, wide area network, the World Wide Web, or any other centralized or decentralized cloud connection. Further distributing the tiled segments from said second data memory onto third data memories through at least one second data connection comprising wired or wireless interfaces including, but not limited to, wireless radio frequency protocols such as Bluetooth, Bluetooth Low Energy, or WiFi, or wired interfaces such as USB, UART, SPI, or I2C.

Each third data memory is contained in a separate enclosure that also contains one third processing unit connected to the third data memory and at least one display screen connected to one of the third processing units, and an electronic means to receive data through at least one of the wired or wireless interfaces, with the electronic means to receive data via the at least one second data connection, with the electronic means connected to one of the third processing units. Each third data memory receives one tiled segment, for each at least one image, per at least one display screen contained in the corresponding enclosure, wherein the one tiled segment is displayed on the attached display screen upon receiving on the third data memory or at a later time.

Each of the separate enclosures further contains at least one connector that permits the formation of a mechanical- and data connection with another one among the separate enclosures such that display screens of thus connected enclosures align to show part of a composite image, wherein not all of the separate enclosures are initially connected together through one of the at least one connector. The user assembles separate enclosures together by mating connectors, thus aligning image segments shown on display screens contained in the separate enclosures, with the goal of solving the puzzle to assemble image segments into one among a set of correct images corresponding to the at least one image originally segmented.

Different, or similar, embodiments include a method that includes some or all of the following features: connecting a first processing unit to more than one second processing units through a first wireless data connection including, but not limited to, Bluetooth, Bluetooth Low Energy, or WiFi. The first processing unit is attached to a user interface through which a user issues instructions which are encoded and distributed to said second processing units. Further connecting a first data memory to said second processing units through a second wired or wireless data connection including, but not limited to, wireless radio frequency protocols such as Bluetooth, Bluetooth Low Energy, or WiFi, or wired interfaces such as USB. The second processing units are connected to one second data memory each. Each processing units is equipped with an instruction set to facility retrieval of data from the first data memory to the second data memory it is connected to via the second data connection.

A user issues instructions to distribute regularly or irregularly tiled segments comprising at least one image stored on the first data memory onto the second data memories. Each of the second processing units retrieves at least one image segment and stores it on its connected second data memory. Each second processing unit and second data memory are contained in a separate enclosure that also contains at least one display screen connected to one of the processing units. Each second processing units retrieves at least one image segment per display screen contained in the corresponding enclosure. The at least one image segment is displayed on the attached at least one display screen upon receiving on the second data memory or at a later time. Each of the separate enclosures further contains at least one connector that permits the formation of a mechanical- and data connection with another one among the separate enclosures such that display screens of thus connected enclosures align to show part of a composite image, wherein not all of the separate enclosures are initially connected together through one of the at least one connector. A second user assembles separate enclosures together by mating connectors, thus aligning image segments shown on display screens contained in the separate enclosures, with the goal of solving the puzzle to assemble image segments into one among a set of correct images corresponding to the at least one image originally segmented and stored on the first data memory.

Advantageously, the method of the present invention segments the images or series of images such as movies and the distribution of image segments onto different devices for reassembly. By reassembling a set of image segments in a 2D or 3D pattern, an image results if the puzzle pieces are assembled in a correct configuration. The image resulting from a correct configuration is associated with a subject matter. The subject matter may be a topic taught in a formal or informal education setting, a subject of play or entertainment, an image that is deemed useful in a therapeutic setting or deemed entertaining for children in a childcare setting. Teachers, proctors, education facilitators, parents, therapists, curriculum designers, or other caregivers and persons tasked with imparting knowledge can arbitrarily reconfigure the puzzle as often as they find it useful for teaching purposes. There is no limitation on the number of themes or topics to be addressed at the same time, since the images or themes displayed are only limited by the resolution and color capability of each display element.

While the disclosure has been described with reference to exemplary embodiments, it will be understood by those skilled in the art that various changes may be made and equivalents may be substituted for elements thereof without departing from the scope of the disclosure. In addition, many modifications may be made to adapt a particular system, device or component thereof to the teachings of the disclosure without departing from the essential scope thereof. Therefore, it is intended that the disclosure not be limited to the particular embodiments disclosed for carrying out this disclosure, but that the disclosure will include all embodiments falling within the scope of the appended claims. Moreover, the use of the terms first, second, etc. do not denote any order or importance, but rather the terms first, second, etc. are used to distinguish one element from another.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The description of the present disclosure has been presented for purposes of illustration and description, but is not intended to be exhaustive or limited to the disclosure in the form disclosed. Many modifications and variations will be apparent to those of ordinary skill in the art without departing from the scope of the disclosure. The described embodiments were chosen and described in order to best explain the principles of the disclosure and the practical application, and to enable others of ordinary skill in the art to understand the disclosure for various embodiments with various modifications as are suited to the particular use contemplated.

What is claimed is:

1. A system for delivering segmented content to a set of reconfigurable puzzle components, the system comprising:
one or more first processing units;
memory accessible by the one or more first processing units and storing a segmentation program that, when executed by the one or more processing units, causes the one or more processing units to:
segment a digital image that covers a surface into a set of sub-images; and
transmit the set of sub-images, along with meta-data indicating respective positions of the sub-images within the digital image and other information related to the digital image, to one or more second processing units associated with the set of puzzle components, wherein each sub-image is transmitted to one puzzle component of the set of puzzle components; and
a plurality of electronic devices each configured as one of the set of puzzle components, each of the plurality of electronic devices comprising:
at least one data memory configured to store one or more of the sub-images;
one or more display screens configured to display the one or more sub-images stored in the at least one data memory;
one or more connectors each configured to mechanically and electrically connect to a corresponding one of the one or more connectors of another of the electronic devices, enabling an alignment of the display screens belonging to different puzzle components, such that the display screens of connected puzzle components form part of a composite image; and
at least one of the one or more second processing units configured to receive one or more of the sub-images and to execute a set of instructions to control the display of sub-images on the one or more display screens;
wherein the assembly of the composite image is configured to support educational, medical, therapeutic, or entertainment goals of a user assembling the set of puzzle components.

2. The system of claim 1, wherein each of the plurality of electronic devices further comprises an attached user feedback sensor, the second processing unit corresponding to the electronic device being further configured to detect an interaction of the user with the user feedback sensor and produce a modified image displayed on at least one display screen of the plurality of electronic devices.

3. The system of claim 1, wherein at least one puzzle component of the set of puzzle components is attached to at least one sensor that permits user input comprising one of: a tactile feedback sensor including a touchscreen, and a voice feedback sensor including a microphone with an attached audio processor.

4. The system of claim 1, wherein the one or more second processing units corresponding to at least one of the plurality of electronic device is further configured to record a duration of puzzle components assembled together as a time record, wherein the time record of assemblies and disassemblies of pair-wise puzzle components is saved in the data memory as an assembly record.

5. The system of claim 1, wherein the user, while assembling the puzzle components, interacts with at least one puzzle component of the set of puzzle components with an attached user feedback sensor, and wherein at least one of the second processing units stores data generated by the user interaction in the data memory as a feedback record.

6. The system of claim 1, wherein the at least one second processing unit is further configured to generate:
a positive feedback signal associated with the user connecting the plurality of electronic devices together to form the composite image matching one or more puzzle solutions including the segmented digital image; and
a negative feedback signal associated with the user connecting the plurality of electronic devices together to form the composite image not matching one of the one or more puzzle solutions.

7. The system of claim 6, wherein the positive feedback signal and the negative feedback signal are recorded in the data memory as a quantitative completion record.

8. The system of claim 1, wherein the user, while assembling the puzzle components, interacts with at least one puzzle component of the set of puzzle components with an attached user feedback sensor, and wherein at least one of the one or more second processing units is further configured to:
store data generated by the user interaction in the data memory as a feedback record;
record a plurality of durations of the set of puzzle components assembled together as time records, wherein the time record includes instance data for assemblies and disassemblies of pair-wise puzzle components;
store the time records in the data memory as an assembly record;
generate a positive feedback signal associated with the user connecting the plurality of electronic devices together to form the composite image matching one or more puzzle solutions including the segmented digital image;
generate a negative feedback signal associated with the user connecting the plurality of electronic devices together to form the composite image not matching one of the one or more puzzle solutions; and
associate occurrences of one or both of the positive feedback signal and the negative feedback signal to produce a quantitative completion record; and
wherein at least one of the one or more first processing units is further configured to receive and analyze the assembly record, feedback record, and quantitative completion record to produce at least one continuously updated quantitative proficiency score.

9. The system of claim 8, wherein the quantitative proficiency record evaluates an adequacy of a level of difficulty encountered by the user when assembling the puzzle components together.

10. The system of claim 1, wherein at least one of the one or more first processing units is further configured to provide a quantitative exit score to measure an amount of exposure completed by the user to a specific segmented image.

11. The system of claim 10, wherein at least one of the one or more first processing units is further configured to compare the quantitative exit score to a first threshold, and to produce a quantitative proficiency score once the quantitative exit score exceeds the first threshold.

12. The system of claim 11, wherein at least one of the one or more first processing units is further configured to compare the quantitative proficiency score to a second threshold, wherein:
a series of customized themes depicted as images are modified towards images that are easier to assemble when segmented or towards a lower number of segments if the quantitative proficiency score is below the second predetermined threshold, and
the series of customized themes depicted as images are modified towards images that are more challenging to assemble when segmented, or the series of customized segmentations towards a greater number of segments if the quantitative proficiency score is above the second predetermined threshold.

13. The system of claim 1, wherein the one or more second processing units are further configured to transmit one or more regularly or irregularly tiled segments, wherein each tiled segment comprises at least one image from a first data memory attached to the first processing unit to at least one second data memory attached to the second processing unit via a first data connection comprising at least one wired or wireless data network.

14. The system of claim 13, wherein the one or more second processing units are further configured to distribute the tiled segments from the second data memory onto one or more third data memories through at least one second data connection comprising wired or wireless interfaces.

15. A system for generating content to be transmitted to a puzzle set, the system comprising:
a content generating device configured to generate the content, wherein the content generating device is a physical or virtual server for remote operation, running in at least one data center;
a second device configured to communicate with the content generating device via at least one networked connection, wherein the system allows a user to operate the content generating device via the second device; and
a data transmitting device configured to transmit the content from the content generating device through at least one data network;
wherein the content is then transmitted to the puzzle set, wherein each puzzle component in the puzzle set comprises a display screen configured to display a segment of the content in an aligned manner.

16. The system of claim 15, further comprising one or more input devices having a touchscreen, mouse, keyboard, scanner, camera, or microphone, configured to design the content, wherein some of the input devices are directly connected to the second device.

17. The system of claim 15, further comprising a data repository with one or more databases of content accessible through a network and the content generating device, wherein the content compatible to the puzzle set is retrieved after initiation by a program running on the content generating device.

18. The system of claim 17, wherein the content retrieved from one database of the one or more databases includes images or series of images, movies, audio files, haptics programs, any other data output for at least one puzzle piece of the puzzle set, and programs and configuration files for at least one puzzle piece of the puzzle set.

19. The system of claim 15, further comprising a content analysis engine configured to receive and analyze sensor data generated by the user interacting with one or more input devices integrated in at least one puzzle piece from among the puzzle set.

20. The system of claim 19, wherein the content analysis engine retrieves data from the puzzle set following a schedule preset in time or depending on analysis results of data retrieved from the puzzle set.

21. The system of claim 20, wherein the content generating engine configures the puzzle set to administer at least one cognitive test and the content analysis engine performs analysis of the at least one cognitive test following established clinical practice.

22. The system of claim 20, wherein the content generating engine configures the puzzle set to administer a cognitive therapy program as evidenced by clinical practice and the content analysis engine monitors the effectiveness of the therapy.

23. The system of claim 15, wherein the content generating engine delivers a subscription to curriculum content to at least one puzzle piece of the puzzle set.
